(19) United States
(12) Patent Application Publication
(10) Pub. No.: US 2026/0276494 A1
(43) Pub. Date: Sep. 17, 2026

(54) MOLECULE ENRICHMENT USING SPATIALLY NON-UNIFORM ALTERNATING CURRENT ELECTRIC FIELD

(71) Applicant: UNIVERSITY OF HOUSTON SYSTEM, Houston, TX (US)

(72) Inventor: Ran An, Houston, TX (US)

(73) Assignee: UNIVERSITY OF HOUSTON SYSTEM, Houston, TX (US)

(21) Appl. No.: 19/168,868

(22) PCT Filed: Mar. 25, 2024
(86) PCT No.: PCT/US2024/021289

§ 371 Date: Sep. 25, 2025

Related U.S. Application Data
(60) Provisional application No. 63/454,641, filed on Mar. 25, 2023.

(51) Int. Cl. G01N 1/40

(52) U.S. Cl. CPC G01N 1/40; G01N 2001/4038

(57) ABSTRACT

Embodiments of the present disclosure pertain to methods of enriching one or more molecules in a medium by applying a spatially non-uniform alternating current electric field (AC electric field) to the medium, where the AC electric field enriches the molecules in the medium through initiating electromigration of the molecules. The methods may also include steps of sensing and/or purifying the molecules. Additional embodiments of the present disclosure pertain to systems for enriching one or more molecules, where the system includes a housing unit operational to house a medium that includes the molecules to be enriched, and an electrode operational to be electrically connected to the medium and apply an AC electric field to the medium.

### CROSS-REFERENCE TO RELATED APPLICATIONS

This application claims priority to U.S. Provisional Patent Application No. 63/454,641, filed on Mar. 25, 2023. The entirety of the aforementioned patent application is incorporated herein by reference.

### BACKGROUND

A need exists for more sensitive methods to enrich, detect, quantify, and/or monitor molecules. Numerous embodiments of the present disclosure address the aforementioned need.

### SUMMARY

In some embodiments, the present disclosure pertains to methods of enriching one or more molecules in a medium. In some embodiments, the methods of the present disclosure include applying a spatially non-uniform alternating current electric field (AC electric field) to the medium. In some embodiments, the AC electric field enriches the molecules in the medium through initiating electromigration of the molecules. In some embodiments, the methods of the present disclosure also include methods of sensing and/or purifying the molecules. In some embodiments, the molecular enrichment occurs in a continuous manner.

Additional embodiments of the present disclosure pertain to systems for enriching one or more molecules. In some embodiments, the system includes a housing unit that is operational to house a medium that includes the molecules to be enriched. In some embodiments, the system also includes an electrode that is operational to be electrically connected to the medium and apply a spatially non-uniform alternating current electric field (AC electric field) to the medium.

### BRIEF DESCRIPTION OF THE DRAWINGS

FIG. 1 illustrates a method of enriching molecules in a medium by applying a spatially non-uniform alternating current electric field (AC electric field) to the medium.

FIGS. 2A-2D depict a system for enriching molecules. FIG. 2A shows a photo of the device with the fluid channel filled with green dye. The box indicates the working fluidic chamber. FIG. 2B shows the box area under a 10× microscope. FIG. 2C shows a side view of the device. FIG. 2D shows a COMSOL simulation of the gradient of the electric field in the labeled area in FIG. 2B at a single time point. All numbers are in micrometers.

FIGS. 3A-3D show the results of a dye properties study. FIG. 3A shows a photobleaching property for fluorescein-5-isothiocyanate (FITC). FIG. 3B shows a photobleaching property for Rb.

FIG. 3C shows an FITC emission intensity calibrated with the FITC concentration. FIG. 3D shows the Rb emission intensity calibrated with the Rb concentration (n=3 for all curves).

FIGS. 4A-4P show comparison experiments under 100 Hz, 10 Vpp. The first column is t=0 (FIG. 4A), 7 (FIG. 4E), and 60 s (FIG. 4I) and the Rb intensity difference (FIG. 4M) obtained by MATLAB image analysis of experiments under a uniform electric field. The second column is the same times and image output of FITC intensity (FIGS. 4B, 4F, 4J and 4N). The third column is the same times and image output of experiments under a nonuniform electric field for ionized FITC (FIGS. 4C, 4G, 4K and 4O). The fourth column is the same times and image output of experiments under a nonuniform electric field for nonionized Rb dye in a nonuniform electric field (FIGS. 4D, 4H, 4L and 4P). An intensity increase can be observed in FIG. 4O, while no change is observed in FIGS. 4M, 4N, and 4P.

FIGS. 5A-5D show spatial FITC emission intensities at t=7 s (FIG. 5A) and t=30 s (FIG. 5B), which demonstrated similarity to the spatial distribution of electric field density (FIGS. 5C-5D). Both FIGS. 5C and 5D contain the same group of data, while FIG. 5C shows the field density on a scale from 1×10⁹ to 5×10⁹. FIG. 5D shows data on a scale from 0.4×10⁹ to 2×10⁹ for the purpose of visualization. These results indicate that the FITC ion concentration enriched from the highest field density area, which then expanded down the electric field gradient with lower concentrations in the peripheral areas.

FIGS. 6A-6D show grayscale two-dimensional (2-D) FITC concentration plot obtained from a MATLAB image analysis at t=0, 7, 30, and 60 s under 10 Vpp 100 Hz. FIGS. 6E-6H show a 3-D MATLAB plot at the same time point. FIGS. 61-6L show a Matlab contour plot showing the FITC concentration gradient. Boxes A-F in FIG. 6M shows the positions of sampled intensity. Curves A-F in FIG. 6N demonstrate the time dependency of the averaged FITC concentration within each corresponding boxed area A-F. Curve G demonstrates the averaged intensity within the entire imaged area.

FIGS. 7A-7B show potential dependency (5-10 Vpp) of the FITC concentration at 100 Hz (FIG. 7A) and frequency dependency (100-500 Hz, 5-25 times electrode charging frequency) of the FITC concentration at 10 Vpp (FIG. 7B). The FITC concentration change increased with peak-to-peak potential and decreased with frequency.

### DETAILED DESCRIPTION

It is to be understood that both the foregoing general description and the following detailed description are illustrative and explanatory and are not restrictive of the subject matter, as claimed. In this application, the use of the singular includes the plural, the word “a” or “an” means “at least one,” and the use of “or” means “and/or” unless specifically stated otherwise. Furthermore, the use of the term “including,” as well as other forms, such as “includes” and “included”, is not limiting. Also, terms such as “element” or “component” encompass elements or components comprising one unit and elements or components including more than one unit unless specifically stated otherwise.

The section headings used herein are for organizational purposes and are not construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials define a term in a manner that contradicts the definition of that term in this application, this application controls.

Methods to enrich molecules have numerous limitations. For instance, availability of assays for low concentration molecules are limited due to their finite limit of detection (i.e., minimum detectable concentration). For example, in wearable electrochemical biosensing and biomonitoring systems, neuropeptide Y (NPY) concentration in sweat is as low as <50 pg/mL. Moreover, NPY isoforms are at even lower concentrations. Other biomolecules of interest may be at even lower concentrations.

Additionally, the ability to generate stable, spatiotemporally controllable concentration gradients is desirable for both electrokinetic and biological applications, such as directional wetting and chemotaxis. Such electrochemical techniques for generating solution and surface gradients display benefits such as simplicity, controllability, and compatibility with automation.

In fact, spatial and temporal gradients are desirable both in solution and on surfaces of many systems and applications. In biological systems, gradients play important roles in cell signaling, migration, differentiation, and metastasis. In electrokinetic-relevant applications, gradients are utilized for high-throughput material screening and to steer molecular motion, among others.

Conventional gradient-generation platforms are based predominantly on diffusion, printing, dip coating, or irradiation. These techniques, however, only produce static, monotonic gradients that have fixed physiochemical properties. On the other hand, studying dynamic biomolecular responses and controlling molecular motion both require spatially and temporally controllable gradients.

Microfluidic platforms have been used to generate chemical gradients that feature spatial and temporal control. However, the majority of microfluidic-based gradient-generation systems employ passive mixing or free-diffusion, resulting in gradients with limited spatiotemporal resolution.

In contrast to the passive generation of concentration gradients, electrochemical techniques actively create dynamic surface gradients that feature compelling controllability and flexibility. Additionally, electrochemical gradient-generation techniques are highly versatile, are compatible with organic and inorganic systems, can be integrated with electronics, and are easily automated.

However, current electrochemical gradient-generation approaches are based on mass transfer induced by Faradaic reactions, gradients derived from in-plane potential gradients, bipolar electrochemical gradients, gradients produced using an asymmetric electrode configuration, as well as combinations of electrochemistry with other methods such as photomask, dip coating, and magnetic field. Many of these approaches rely on Faradaic reactions (Ri) that yield species accumulation for gradient generation.

As such, a need exists for more sensitive methods to enrich, detect, quantify, and/or monitor molecules. Numerous embodiments of the present disclosure address the aforementioned need.

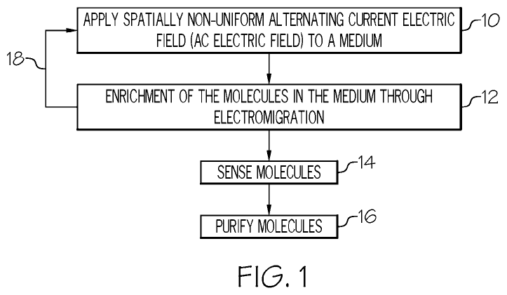

In some embodiments, the present disclosure pertains to methods of enriching one or more molecules in a medium. In some embodiments illustrated in FIG. 1, the methods of the present disclosure include applying a spatially non-uniform alternating current electric field (AC electric field) to the medium (step 10). In some embodiments, the AC electric field enriches the molecules in the medium through initiating electromigration of the molecules (step 12). In some embodiments, the methods of the present disclosure also include steps of sensing (step 14) and/or purifying (step 16) the molecules. In some embodiments, the molecular enrichment occurs in a continuous manner (step 18).

Additional embodiments of the present disclosure pertain to systems for enriching one or more molecules. In some embodiments, the system includes a housing unit that is operational to house a medium that includes the molecules to be enriched. In some embodiments, the system also includes an electrode that is operational to be electrically connected to the medium and apply a spatially non-uniform alternating current electric field (AC electric field) to the medium.

As set forth in more detail herein, the methods of the present disclosure can have numerous embodiments. For instance, the methods and systems of the present disclosure may be utilized to enrich various molecules from various media for various purposes.

### AC Electric Fields

The methods and systems of the present disclosure may apply various types of spatially non-uniform alternating current electric fields (hereinafter “AC electric field”). For instance, in some embodiments, the spatially non-uniform AC electric field is defined by the following formula:

$$\frac{{z}_{i} F}{RT} {D}_{i} {C}_{i} {\vec{∇}}^{2} ⌀ \neq 0.$$

In some embodiments, Zᵢ is the valence of the molecules, F is Faraday's constant, R is the gas constant, T is the medium temperature, Dᵢ is the diffusion coefficient, Cᵢ is the molecule concentration, and φ is the electric potential applied to the medium. Due to the spatial non-uniformity, the time average of the gradient of electric field is a non-zero term as described in the above equation.

AC electric fields may be applied to a medium in various manners. For instance, in some embodiments, the AC electric field is applied to the medium through an electrode. In some embodiments, the AC electric field is applied to the medium through an electrode pair. The methods and systems of the present disclosure may utilize various types of electrodes. For instance, in some embodiments, the electrode contains a conductive layer and a dielectric layer. In some embodiments, the conductive layer provides the electric field while the dielectric layer inhibits electron-transfer induced electrochemical reactions while still allowing the electric field to affect the charged molecules within the solution.

The electrodes of the present disclosure may include various types of conductive layers. For instance, in some embodiments, the conductive layer includes a metal-based layer. In some embodiments, the metal-based layer includes titanium (Ti), gold (Au), or combinations thereof. In some embodiments, the conductive layer includes a titanium (Ti)-based electrode, a gold (Au)-based electrode, or combinations thereof.

The electrodes of the present disclosure may include various types of conductive layers in various arrangements with a conductive layer. For instance, in some embodiments, the dielectric layer is positioned above the conductive layer. In some embodiments, the dielectric layer includes a pin-hole fee dielectric layer. In some embodiments, the dielectric layer includes a Hafnium Dioxide (HfO₂) layer.

In some embodiments, the electrodes of the present disclosure include a Hafnium Dioxide (HfO₂)-based dielectric layer coated on a conductive layer that includes Ti and Au. In some embodiments, the dielectric layer blocks electron exchange between the conductive layer and the medium.

### Electromigration

AC electric fields in the present disclosure may enrich molecules in a medium in various manners. For instance, in some embodiments, AC electric fields in the present disclosure may enrich molecules in a medium through initiating electromigration of the molecules.

Electromigration may occur in various manners. For instance, in some embodiments, electromigration occurs without Faradaic reactions. In some embodiments, electromigration occurs without the molecules undergoing a chemical reaction. In some embodiments, electromigration occurs without the molecules undergoing an electrochemical reaction. In some embodiments, electromigration occurs without the polarization of the molecules. In some embodiments, electromigration occurs in a spatiotemporally controllable manner. In some embodiments, electromigration occurs independently from bulk convective flow. In some embodiments, electromigration occurs through an electrokinetic mechanism.

Electromigration may occur in various directions in a medium. For instance, in some embodiments, electromigration is directed along the AC electric field. In some embodiments, electromigration is directed towards a first electrode of an electrode pair that provides the AC electric field, and away from a second electrode of the electrode pair.

Within an AC electric field, ions electromigration tend to oscillate with time along the electric field lines. However, in spatially non-uniform AC electric fields, ions electromigrated from lower electric field density areas toward higher electric field density areas.

### Enrichment of Molecules

The methods and systems of the present disclosure may enrich various types of molecules. For instance, in some embodiments, the molecules include, without limitation, charged molecules, uncharged molecules, macromolecules, biomolecules, proteins, or combinations thereof. In some embodiments, the systems of the present disclosure also include the molecules to be enriched.

In some embodiments, the molecules include biomolecules. In some embodiments, the biomolecules include, without limitation, glucose, electrolytes, sodium, potassium, ammonium, metabolites, lactate, ethanol, heavy metals, zinc, neuropeptides, or combinations thereof.

Molecular enrichment may occur in various manners. For instance, in some embodiments, enrichment includes selective enrichment of molecules over other molecules. In some embodiments, enrichment separates the molecules from other molecules. In some embodiments, enrichment results in the concentration of the molecules.

In some embodiments, molecule enrichment occurs in a continuous manner. In some embodiments, molecular enrichment occurs in batches.

In some embodiments, the methods of the present disclosure also include a step of controlling the level of enrichment. In some embodiments, the controlling includes adjusting at least one of voltage, frequency, amplitude, or potential of the AC electric field.

### Molecular Enrichment Media

The molecules of the present disclosure may be enriched in various types of media. In some embodiments, the systems of the present disclosure also include the medium. In some embodiments, the medium includes a gaseous medium, a liquid medium, a solid medium, or combinations thereof. In some embodiments, the medium includes a liquid medium, a solid medium, or combinations thereof. In some embodiments, the medium includes a solid medium.

In some embodiments, the medium includes a liquid medium. In some embodiments, the liquid medium includes electrolytes. In some embodiments, the electrolytes include ionized Fluorescein isothiocyanate (FITC). In some embodiments, the liquid medium lacks water. In some embodiments, the liquid medium includes a non-ionic solvent. In some embodiments, the non-ionic solvent includes methanol.

In some embodiments, the methods of the present disclosure also include a step of collecting a medium that includes the molecules to be enriched. In some embodiments, the medium includes the natural environment for the molecules to be enriched. For instance, in some embodiments where biomolecules are being enriched, the medium may include, without limitation, blood samples, sweat samples, tissue samples, or combinations thereof. In some embodiments where molecules from an environment are being enriched, the medium may include water samples, air samples, soil samples, or combinations thereof.

### Sensing of the Molecules

In some embodiments, the methods of the present disclosure also include a step of sensing the one or more enriched molecules. In some embodiments, the systems of the present disclosure also include a sensor for sensing the one or more enriched molecules. In some embodiments, the sensing occurs through utilization of one or more electrodes utilized for enrichment. In some embodiments, the sensing occurs through utilization of one or more electrodes not utilized for enrichment. In some embodiments, the one or more electrodes utilize different electrical signals. In some embodiments, the sensing further includes quantifying the concentration of the one or more molecules.

### Purification of the Molecules

In some embodiments, the methods of the present disclosure also include a step of purifying the enriched molecules. In some embodiments, purifying includes collection of the enriched molecules from the medium.

### Housing Units

The systems of the present disclosure may include various types of housing units. For instance, in some embodiments, the housing units are in the shape of a box. In some embodiments, the housing unit is in the shape of a container. In some embodiments, the housing unit is in the form of a chamber. In some embodiments, the chamber is in the form of a fluidic chamber.

### System Forms

The systems of the present disclosure may be in various forms. For instance, in some embodiments, the systems of the present disclosure are in the form of a microfluidic system, a sensor, a wearable sensor, or combinations thereof. In some embodiments, the system is in the form of a wearable sensor.

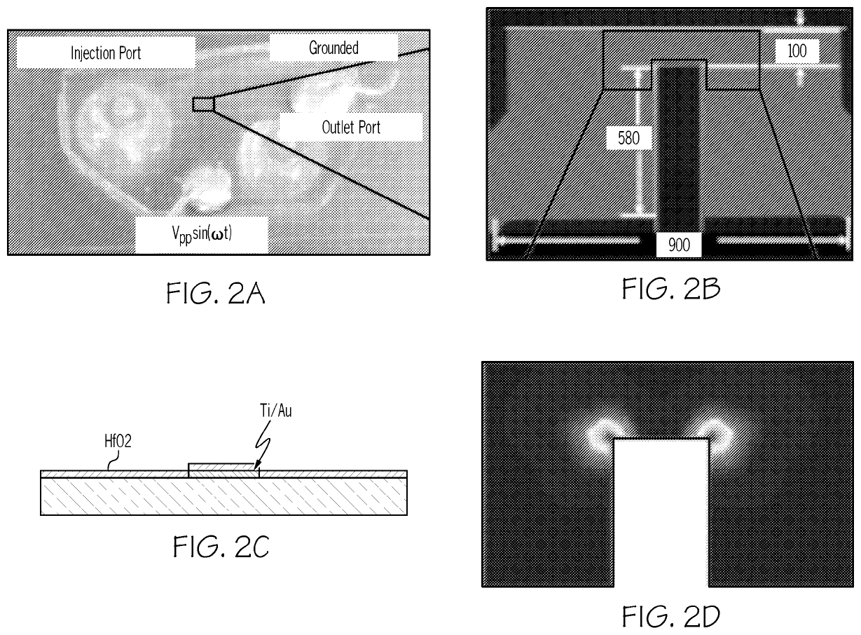

An example of a system of the present disclosure is illustrated in FIGS. 2A-2D. In particular, FIG. 2A illustrates a photo of the system with fluid channels filled with green dye, where the box indicates the working fluidic chamber. FIG. 2B shows the box area under a 10× microscope. FIG. 2C shows a side view of the system. FIG. 2D shows concentrated molecules within the system in a three-dimensional (3D) mesh plot under the impact of the spatially non-uniform AC electric field.

### Additional Embodiments

Reference will now be made to more specific embodiments of the present disclosure and experimental results that provide support for such embodiments. However, Applicant notes that the disclosure below is for illustrative purposes only and is not intended to limit the scope of the claimed subject matter.

### Example 1. Reaction-Free Concentration Gradient Generation in Spatially Nonuniform AC Electric Fields

In this Example, Applicant presents a new technology that allows one to concentrate or enrich molecules using an alternating current (AC) electric field, which is not dependent on electrochemical reactions, and which occurs through a reaction-free electrochemical/electrokinetic method. Briefly, this technology leverages the benefit of electric field gradient, and stably enriches charged molecules at a quasi-equilibrium state, in a stable and spatiotemporally controllable manner.

Additionally, the magnitude and the spatiotemporal behavior of the concentrations can be precisely controlled by the combination of applied voltage and frequency. Furthermore, this pre-concentration approach can be operated in both continuous and batch conditions, thereby increasing sensing sensitivity. Additionally, the methods of the present disclosure have a potential to selectively increase concentration of designated molecules over the others, which would also increase sensing specificity.

Applicant demonstrated molecular enrichment in a system using methanol solutions with ionized Fluorescein isothiocyanate (FITC) molecules as the electrolyte. Spatially non-uniform alternating current (AC) electric fields were applied using Hafnium Dioxide (HfO₂) coated Ti/Au electrode pairs. Results from spatial and temporal analysis, along with control experiments, suggest that the FITC concentration can be increased within a specified area to up to 5 folds. The established fold of concentration increments are dependent on both amplitudes and the frequencies of the oscillating AC electric field.

Once the target molecule in enriched, biosensing may be conducted over the original pair(s) of electrodes which were used to increase the concentration. Alternatively, biosensing can be conducted using additional pair(s) of electrodes using different electric signals.

### Example 1.1. Approach

The fundamental theory for electrochemical concentration gradient generators is based on ion mass transfer, which can be described by the combination (equation 3) of the Nernst-Plank (equation 1) and mass-conservation (equation 2) equations.

$${\vec{J}}_{i} = - {D}_{i} \text{?} {C}_{i} - \frac{{z}_{i} F}{RT} {D}_{i} {C}_{i} \text{?} ⌀ + {C}_{i} \vec{v} \qquad Equation 1$$

$$\frac{\partial {C}_{i}}{\partial t} + \text{?} \cdot {\vec{J}}_{i} + {R}_{i} = 0 \qquad Equation 2$$

$$\frac{\partial {C}_{i}}{\partial t} = {D}_{i} {\vec{∇}}^{2} {C}_{i} + \frac{{z}_{i} F}{RT} {D}_{i} {C}_{i} {\vec{∇}}^{2} ⌀ - {C}_{i} \vec{v} + {R}_{i} \qquad Equation 3$$

$$\text{?} \text{indicates text missing or illegible when filed}$$

In the aforementioned equations, Jᵢ, Dᵢ, Cᵢ and zᵢ are Ji re the flux (vector), diffusion coefficient, concentration, and valence of species i, respectively, R is the gas constant, T is temperature, F is Faraday's constant, ø is electric potential, \vec{v} is convective flow velocity (vector), t is time, and Ri is the reaction rate for species i. In equations 1-3, Jᵢ, Ci, ø, and \vec{v} concurrently display time dependence and spatial dependence, e.g., f(t, x, y) in this system. From equation 3, the time dependence of ion concentration for species i within a fluid can be induced by chemical potential gradients, electric potential gradients, convective flows, and species i reactions. Such reactions can be ionic, chemical, and/or Faradaic in nature.

Current electrochemical gradient-generation approaches are based on mass transfer induced by Faradaic reactions, gradients derived from in-plane potential gradients, bipolar electrochemical gradients, gradients produced using an asymmetric electrode configuration, as well as combinations of electrochemistry with other methods such as photomask, dip coating, and magnetic field. Many of these approaches rely on Faradaic reactions (Ri) that yield species accumulation for gradient generation.

According to equation 3, Applicant hypothesized that stable concentration gradients, \vec{∇}2Ci, can be generated using biased electromigration in spatially nonuniform alternating current (AC) electric fields

$$( \frac{{z}_{i} F}{RT} {D}_{i} {C}_{i} {\vec{∇}}^{2} ⌀ \neq 0 )$$

independently from bulk flux (Ci\vec{v}=0) and without Faradaic reactions (Ri=0). To test this hypothesis, ionized fluorescent dye fluorescein isothiocyanate (FITC) was used as a real-time detectable target. To suppress the dominant Faradaic reaction manifesting as water electrolysis, (1) methanol (MeOH) was used as a solvent instead of water and (2) a dielectric layer of hafnium dioxide (HfO2) was implemented over the Ti/Au electrode to block the electron exchange between the electrode metal surface to any residual water molecules.

In this Example, Applicant first performed qualitative control experiments to ascertain impacts on spatiotemporal fluorescent emission intensity from Faradaic reactions as well as convective flow (per mechanisms in Equation 3). This ensured that the fluorescent emission intensity changes detected in the remaining experiments could be decoupled and attributable to electromigration mechanisms.

Thereafter, Applicant performed spatial and temporal analysis of the intensity behavior and visually tabulated the ion concentration gradients using contour plots. Finally, Applicant quantified ion concentration gradients as a function of applied potential from 5 to 10 Vpp (peak-to-peak potential) and frequencies from 5 to 25 times the electrode charging frequency fc, as defined in Equation 4.

### Example 1.2. Materials

Fluorescein isothiocyanate (FITC, 492/518 nm) was utilized as a fluorescing ion source. An FITC (powder ≥90%, Sigma-Aldrich) stock solution was prepared in MeOH (99.99%, Sigma-Aldrich) at 10⁻⁴ M and further diluted to 2 μM during experiments. Rhodamine B (Rb, powder ≥95%, 554/627 nm, Sigma-Aldrich) was utilized as a neutral dye in control experiments. An Rb stock solution was also prepared in MeOH at 10⁻⁴ M and further diluted to 2 μM during experiments. NaCl (>99%, Macron Chemicals) was used in the MeOH solution during the Rb control experiment to provide the same solution conductivity (4.3×10-4 S/m) as the 2 μM FITC solution.

### Example 1.3. Microdevice Design and Fabrication

As illustrated in FIGS. 2A-2D, orthogonally positioned Ti/Au (50/50 nm thickness, 100 μm width) electrode pairs with 100 μm gaps were designed and fabricated following standard soft photolithography fabrication procedures on microscope slides. FIG. 2A shows a layer of 100 nm hafnium dioxide (HfO₂) as the fully assembled microdevice. FIG. 2B shows a 10× magnified view of the experimental fluidic chamber. FIG. 2D shows an expanded view of a region in FIG. 2B.

FIG. 2C shows a side view schematic of the device illustrating the dielectric HfO₂ layer. An Agilent 33250A function generator provided the AC electric signal across the vertical electrode, Vpp sin(ωt), and grounded horizontal electrode were used to drive ion migration within the chamber.

### Example 1.4. Experimental Designs

Two approaches were employed to significantly reduce Faradaic reactions at the electrodes. The first approach employed a dielectric coating hafnium dioxide (HfO₂) previously demonstrated to provide a physical and insulating dielectric layer between the Ti/Au electrodes and the electrolyte while still enabling electric potential penetration into the solvent. The electrical current through the solution, while attenuated slightly by the HfO₂, remained sufficient to induce ion migration within the experimental conditions explored.

The second approach utilized MeOH as an electrochemically inert solvent in place of water. MeOH has been shown to better resist electrolysis. After independently developing concentration/intensity calibration curves, FITC and Rb photobleaching were also quantified separately by continuously detecting emission light intensity in the working chamber under excitation light exposure for 60 s and in the absence of an applied electric potential.

Solutions were prepared by mixing the prepared FITC stock solution and MeOH at a ratio of 1:49, yielding a final FITC concentration of 2 μM for the ion migration detection experiments. Samples were injected into the input port shown in FIG. 2A and sealed with a one-piece fitting (LabSmith, USA). This batch experiment prevented pressure-driven flow within the chamber (separately verified). The experimental matrix included AC signals from 5 to 10 Vpp at 1.25 Vpp intervals and frequencies from 100 to 500 Hz at 100 Hz intervals; this corresponded to 5-25 times fc (Equation 4).

To facilitate a comparison of study results for other systems with various electrode designs and solutions, we utilized a nondimensional frequency, which was obtained by dividing the applied frequency with the electrode charging frequency, fc. The electrode charging frequency captures the propensity of the electric double layer to charge according to equations 4-6.

$${f}_{c} = \frac{1}{2 π {t}_{c}} = \frac{D}{2 {πλ}_{D} L} \qquad Equation 4$$

$${λ}_{D} = \sqrt{\frac{ε RT}{2 {F}^{2} {C}_{0}}} \qquad Equation 5$$

$${f}_{r} = \frac{f}{{f}_{c}} \qquad Equation 6$$

In Equations 4-6, f_{c} is the electrode charging frequency, D is the diffusion coefficient, λ_{D} is the electrical double layer thickness, L is the characteristic length (in this case, the 100 μm spacing between electrodes), ε is the solution relative permittivity, C₀ is the bulk molar concentration, f is the applied frequency, and fᵣ is the relative frequency. Under the experimental conditions of this Example, D=4.9×10⁻¹⁰ m²/s for FITC in methanol, which was roughly estimated via linear proportional analysis of the diffusion coefficient of FITC in water. To the diffusion coefficient of sodium in water and in methanol.

The electrode charging frequency was calculated to be ~20 Hz using the parameters above and ε=33 for FITC in MeOH. Thus, the applied nondimensional relative frequency, fᵣ, ranged from 5 to 25. Video microscopy at 10× magnification was recorded at 1 fps for 60 s. No electric fields were applied in the first five frames to check system stability. Each 60 s experiment was repeated five times with new solutions in the microchamber.

Control experiments were completed to detect convective flow using a mixture of neutrally charged 2 μM Rb dye in a NaCl MeOH solution with NaCl added to achieve −4.3×10⁻⁴ S/m. This was the same final conductivity as the FITC-MeOH solution. Additional control experiments were completed to detect Faradaic reaction byproducts (i.e., pH changes) using a 2 μM FITC-MeOH solution within a uniform electric field without the HfO2 layer.

In addition, the COMSOL Multiphysics (COMSOL, Inc, Burlington, MA) electrostatics module was used to simulate electric field spatiotemporal variations including field strengths and field densities within the inspected system (Extra Fine mesh). As shown in FIGS. 2A-2D, the horizontal electrode at the top of the simulated region was set to a ground condition. The vertical electrode was fixed to 10 Vpp, the left and right boundaries were configured as open, and the remaining boundaries were programmed as insulating.

### Example 1.5. Data Analysis Methods

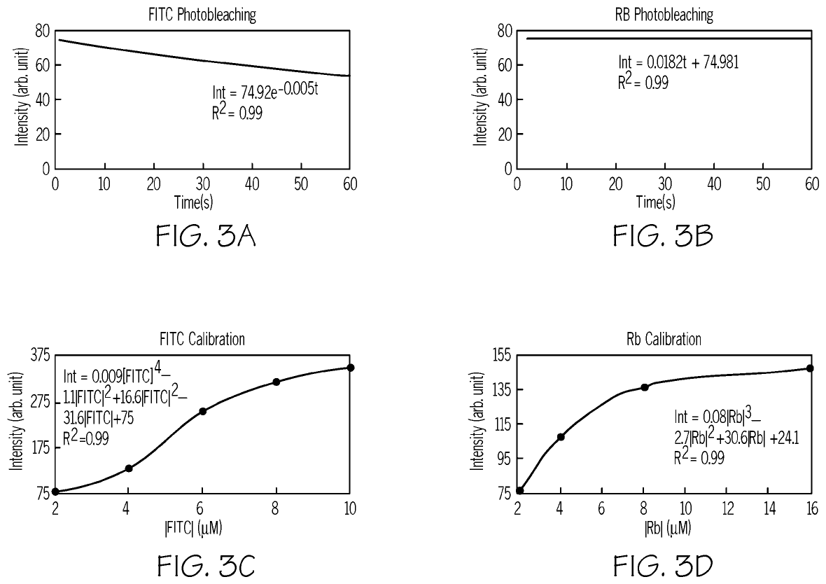

Emission intensities of FITC and Rb dyes were tested independently against time for the effect of photobleaching (FIGS. 3A-3B), and against fixed FITC and Rb concentrations for obtaining each intensity-concentration calibration curve (FIGS. 3C-3D). All acquired microscope videos were exported as 61 (0-60 s) separate images and imported into MATLAB to generate grayscale matrices ranging from 0 (dark) to 255 (bright).

Intensity values of the first five frames (electric fields off) were normalized to 75 to ensure that the brightest regions did not exceed the 255 maximum range. For control experiments, intensity analysis was performed on the acquired video to calibrate for photobleaching (FIGS. 3A-3B). For test experiments, the acquired data were calibrated against photobleaching effects (FIGS. 3A-3B), and then converted to the FITC concentration using the FITC calibration curve (FIG. 3C).

Contour three-dimensional (3-D) mesh image plots were used to aid in visualizing the ion concentration gradient. Contour plots were used to demonstrate the intensity spatiotemporally to discern gradient progression, and 3-D mesh images were used to demonstrate the calculated concentration gradient whereby the z-axis expresses the FITC concentration obtained from the FITC concentration-intensity calibration.

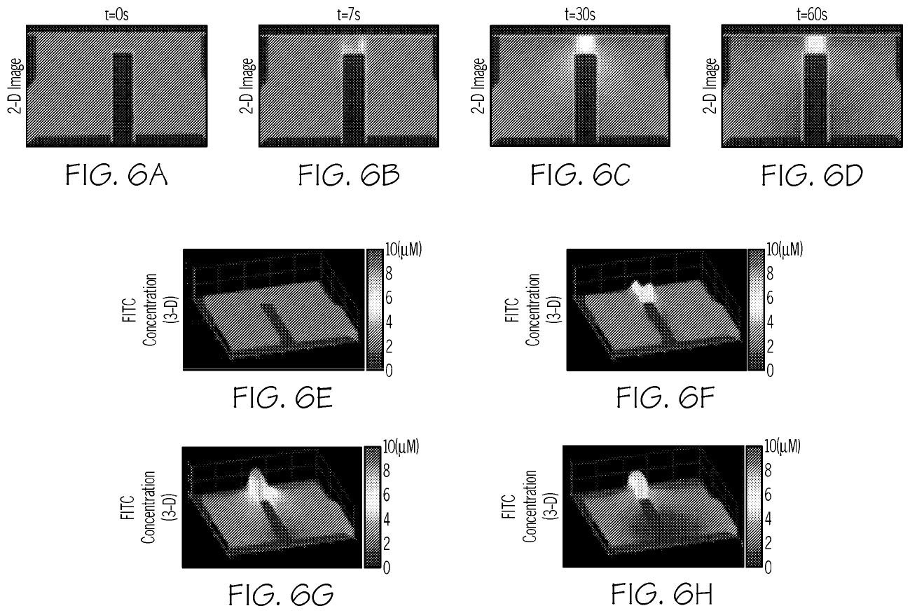

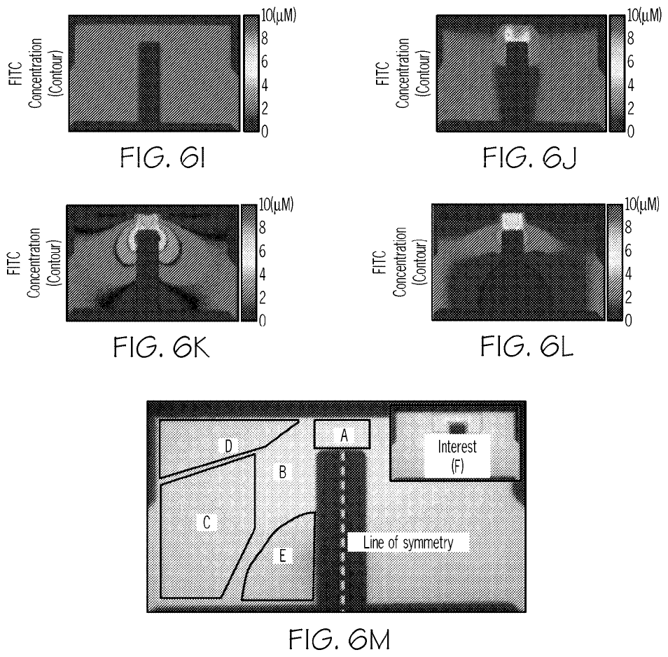

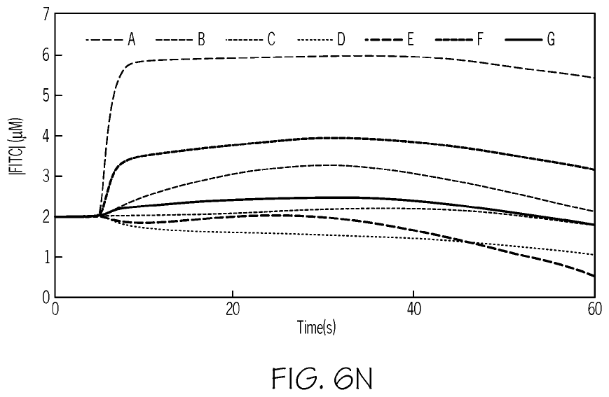

ImageJ was employed to quantify peak-to-peak potential and frequency dependencies. An area of interest (FIG. 6F, total area ~35,000 μm²) was chosen in the high field density region. Additional areas of interest (FIGS. 6A-6E, total areas ~15,000, 30,000, 105,000, 47,000, and 45,000 μm²) were ascertained based on visually uniform intensity over the area. These areas of interest were then used to track emission intensity over time and quantify concentration temporally.

### Example 1.6. Results and Discussion

The FITC anion was selected to measure spatially variant ion concentration in a nonionic MeOH solution. FITC is a fluorescing molecule whose concentration is directly proportional to emission intensity. FITC and Rb were first calibrated to quantify photobleaching effects and to obtain emission intensity versus concentration calibration curves. Control experiments were performed utilizing FITC and Rb to ascertain the extent of Faradaic reactions in two modified devices (nonuniform and uniform) and to determine effects from the convective flow. Spatial emission intensity analysis was performed in the spatially variant electric fields followed by time analysis of ion concentration changes in multiple areas. Finally, ion gradient dependencies on applied potential magnitudes and frequency were quantified.

### Example 1.6. 1. FITC and Rb Calibrations

FITC and Rb calibrations were completed to quantify both photobleaching and intensity-concentration correlations. Photobleaching properties were examined by detecting FITC (FIG. 3A) and Rb (FIG. 3B) emission intensity without applying any potential for 60 s. Results showed that FITC emission intensity decreased from 75 arb. unit to 55, while Rb emission intensity stayed nearly constant at 75 during the entire 60 s. FITC photobleaching can be fit to an exponential function and Rb photobleaching can be fit to a linear function, both with R₂>0.99. These functions were used to correct subsequent experiments to isolate photobleaching effects and obtain net intensity change from dye concentration changes only.

Second, both FITC and Rb concentrations were calibrated with emission intensity, as shown in FIGS. 3C-3D, n=3. Both FITC and Rb emission intensity increased with the dye concentration from 2 to 12 μM. Polynomial equations were fit with R2>0.99. Once experiments were conducted in electric fields, FITC intensity was corrected to isolate concentration only effects using the calibration curves in FIGS. 3A and 3C. Similarly, Rb intensity was corrected to isolate concentration using the calibration curves in FIGS. 3B and 3D.

### Example 1.6.2. Control Experiments

Four sets of control experiments were conducted to elucidate other mechanisms that could potentially impact FITC emission intensity changes. Mechanisms in the Nernst-Plank (Equation 1) including diffusion, reaction, convection, and electromigration impact ion concentrations over time. Diffusion is a passive process that exists in all systems at around 10 μm²/s for FITC molecules. More specifically, the diffusivity of FITC D=4.9×10-10 m²/s yields a diffusion time of t≈x²/2D 10 s to travel the x distance of 100 μm, which is 103 times longer than the period of the AC signal (100 Hz, 0.1 s).

Faradaic reactions occur due to charge transfer at electrode surfaces. These effects need to be examined since reaction byproducts have been shown to affect pH adjacent to the electrodes and thus FITC dye emission intensity. For convective flow, AC electroosmotic flow could potentially be induced at the frequencies and conductivities examined. Such induced flows would transport dye, thus affecting observed emission intensities. Electromigration could not be controlled and was therefore intentionally quantified including comparisons between the ion intensity changes in uniform and nonuniform devices.

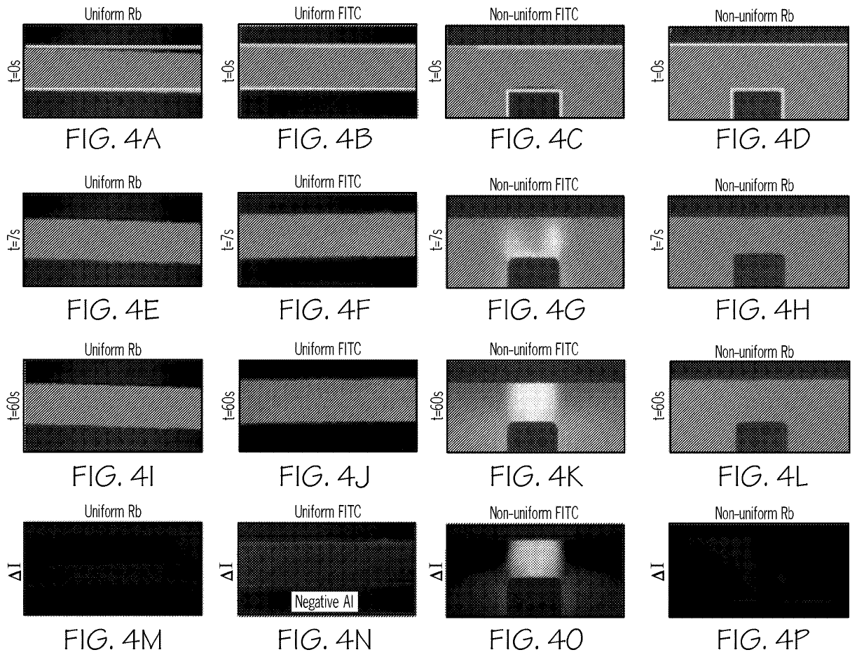

Sinusoidal signals of 10 Vpp at 100 Hz were applied to all four sets of control experiments including neutral Rb dye in uniform electric fields (FIGS. 4A, 4E, 4I, and 4M, 1^{st} column), ionic FITC dye in uniform electric fields (FIGS. 4B, 4F, 4J, and 4N, 2nd column), ionic FITC dye in nonuniform electric fields (FIGS. 4C, 4G, 4K, and 4O, 3^{rd} column), and neutral Rb dye in nonuniform electric fields (FIGS. 4D, 4H, 4L, and 4P, 4^{th} column). Captured data at 0, 7 s (2 s after applying electric fields), and 60 s are shown in row 1-3 FIGS. 4A-4L, respectively.

FIGS. 4M-4P demonstrates the absolute difference between 60 and 0 s to better visualize intensity change over the experiment. In the first column, an Rb—NaCl MeOH solution in a uniform electric field demonstrated nearly constant emission intensity, as shown in FIGS. 4A, 4E, 4I and 4M. Since Rb has also been utilized as a temperature indicator, this result indicates that there is no significant temperature change, which is expected given the low conductivity of the solution. The estimated temperature change would be ~0.01° C. according to Δ=σV²ᵣₘₛ/8k, where σ=0.00043 S/m is the solution conductivity and thermal conductivity, k=0.203, for MeOH at 25° C. Experiments and theory are in agreement. The experimental conditions in this system are thermally stable.

To qualify ion concentration change induced by Faradaic reactions (∂Cᵢ/∂ₜ induced by Rᵢ), an FITC MeOH solution at a conductivity of 4.3×10⁻⁴ S/m was monitored between a pair of parallel electrodes whereby the electric field gradient is nearly zero, ∇² ø=0 (FIGS. 4B, 4F, 4J, and 4N, 2nd row).

Uniform AC electric fields yield zero time-averaged ion migration

$$( [ \frac{{z}_{i} F}{RT} {D}_{i} {C}_{i} \vec{∇} ⌀ ] = 0 ) ,$$

as well as zero convective flow, (Cᵢ=0), while Faradaic reactions remain present (Rᵢ≠0). As a result, all observed intensity shifts (ΔI) in uniform fields can be attributed to Faradaic reactions. FITC emissions in the uniform electric field remained nearly constant, as illustrated in the second column in FIGS. 4B, 4F, and 4J. A small decrease in intensity was observed in FIG. 4N and calculated over all repeats to have an average magnitude of 7.5 arb. unit. This was attributed to residual Faradaic reactions progressing with the aid of water contamination in MeOH via any HfO2 pits or exposed edges of the Au electrode that can be exposed during the photoresist lift-off process.

While Faradaic reactions do not depend on field uniformities, they do cause shifts in pH that alter FITC intensity; these minor effects are a form of a systematic error and are quantifiable from the uniform field experiments. However, FIG. 4N demonstrates that these residual Faradaic reaction byproducts are so minor (7.5 arb. unit) that they can be decoupled from the mechanism inducing FITC concentration intensity increases in nonuniform electric fields, as shown in FIGS. 4C, 4G, 4K, and 4O.

As shown in the fourth column of FIGS. 4D, 4H, and 4L, controls were also conducted in uniform AC electric fields with the neutral Rb—NaCl solution whereby any observed intensity shift (ΔI) can be attributed to convective flow. The magnitude of intensity change demonstrated in FIG. 4P was ~0. Since the Rb—NaCl and FITC solutions have identical conductivities, any induced ACEO flow would have been similar. The imperceptible Rb intensity change in FIG. 4P indicates that ACEO flow was not induced under these ionic conditions in this system. Thus, convective flow is not the mechanism inducing the observed FITC emission intensity increases in nonuniform electric fields.

The third column in FIGS. 4C, 4G, 4K, and 4O shows FITC in MeOH in the nonuniform electric field. Prior to electric field application, the system initially displays a uniform intensity, as shown in FIG. 4C. The emission intensity starts to increase from the high field density region after 2 s within the electric field, as shown in FIG. 4G. In FIGS. 4K and 4O, significant intensity increases were quantified with an average magnitude of 120 arb. units in the gap between the electrodes at a longer time of 60 s and a longer length scale of ~100 μm.

In conclusion, these control and comparison experiments illustrate that the observed FITC intensity changes in FIGS. 4C, 4G, 4H and 4O are not induced by temperature changes, Faradaic reactions, or convection. Per the N—P mass conservation in Equation 3, electromigration is the remaining ion transport mechanism.

### Example 1.6.3. Proposed Mechanism for the Established Ion Concentration Gradient

Spatially uniform AC fields are traditionally treated as yielding stable and uniform environments. However, ion migration over time in spatially nonuniform AC fields remains ambiguous. Recently, supporting evidence has been advanced that ions experiencing oscillatory migration in AC fields may result in accumulated solution property changes over time.

In this Example, Applicant hypothesized that a stable concentration gradient, \vec{∇}2 Ci, can be generated leveraging the mechanism of biased electromigration in spatially nonuniform AC electric fields

$$( \frac{{z}_{i} F}{RT} {D}_{i} {C}_{i} {\vec{∇}}^{2} ⌀ \neq 0 ) ,$$

independently from bulk convective flow (Ci \vec{v}=0) and Faradaic reactions (Ri=0). At quasi-equilibrium, whereby the total number of ions within the chamber does not change, the time-averaged ion concentration variation with time is zero (∂Cᵢ/∂ₜ=0). In this quasi-equilibrium state, the Nernst-Planck equation (Equation 3) then indicates that the spatial ion concentration gradient, Di\vec{∇}2 Ci, is associated with convection, −Ci\vec{v}, reactions (in this case, Faradaic reactions), Ri, and electric field gradient (ZiF/RT DiCi\vec{∇}2 ø).

The results obtained from the control experiments (FIGS. 4A-4P) indicate that effects from convective flow and Faradaic reactions are nearly negligible, thus Ci v=0, Ri=0. As a result, the simplified N—P conservation equation (Equation 3) describing the experimental conditions can be simplified to the formula shown in Equation 7.

$$- {D}_{i} {\text{?}}^{2} {C}_{i} = \frac{{z}_{i} F}{RT} {D}_{i} {C}_{i} {\text{?}}^{2} ⌀ \qquad Equation 7$$

$$\text{?} \text{indicates text missing or illegible when filed}$$

In spatially nonuniform electric fields, while ø is time dependent, it is concurrently spatially dependent, ø(t, x, y). Therefore, the time-average over each period is characterized as: <\vec{∇}2ø(t, x, y)>≠0. Equation 7 indicates that the intensity change observed in the FITC-MeOH solution in a nonuniform electric field is predominantly induced by electromigration

$$( \frac{{z}_{i} F}{RT} {D}_{i} {C}_{i} {\vec{∇}}^{2} ⌀ \text{?} ) ,$$

$$\text{?} \text{indicates text missing or illegible when filed}$$

leading to a stable establishment of an ion concentration gradient, \vec{∇}2 Ci, within the microfluidic chamber.

Thus, Applicant's hypothesis agrees with the experimental results from control experiments. When \vec{∇}2 ø=0 in uniform electric fields, no ion concentration gradient is established. On the contrary, in nonuniform electric fields, \vec{∇}2 ø≠0, the nonzero gradient of the electric field shown is responsible for inducing an ion concentration gradient. The similar pattern between the experimentally established ion concentration gradient and the electric field gradient calculated from \vec{∇}2 ø also supports this hypothesis.

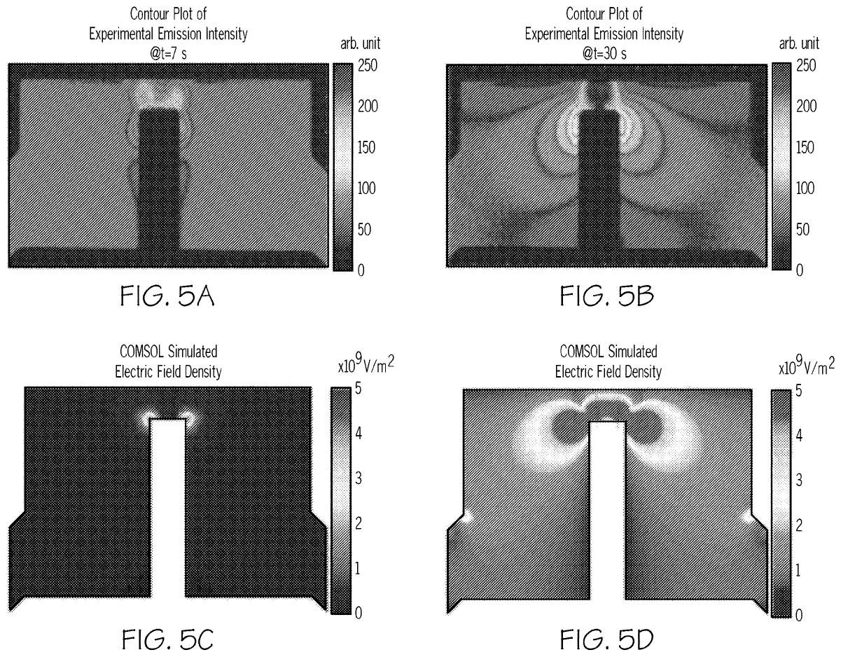

FIGS. 5A-5D show a comparison between the contour plot for emission intensity (FIGS. 5A-5B) of the FITC concentration distribution at t=7 and 30 s alongside the electric field density simulated by Poisson's equation in COMSOL's electrostatics module (FIGS. 5C-5D). For best visualization, FIG. 5C shows the field density on a scale from 1×10⁹ to 5×10⁹ V/m₂, while FIG. 5D shows data on a scale from 4×10⁸ to 2×10⁹ V/m². Rough similarities are visible in FIGS. 5A and 5C, whereby FITC ion concentrations enrich from the highest field density area at the corners of the point electrode in the chamber and progress to dominate the narrow gap between the electrodes.

As time progresses, ion enrichment increases and the enrichment area expands down the electric field gradient with lower concentrations in the peripheral areas. Pattern variations on either side of the vertical electrode when compared between FIGS. 5B and 5D are attributed to minor pH-induced intensity changes and diffusion. pH changes from residual Faradaic reactions could occur at exposed Ti/Au electrode pits or edges, as discussed in Example 1.6.2.

Patterns of more severe ion shifts around a high field density electrode tip were previously observed. In addition, impacts from diffusion, while >100 orders of magnitude less than migration, may also contribute to the slight differences in shape between the actively generated ion concentration gradient and electric field density. Since the lower left and right sides are microfluidic channels (FIGS. 2B and 6M) connected with buffer reservoirs (FIG. 2A), these are functioning as boundaries with a constant concentration. As a result, ion diffusion can occur in this limited cross section between the bulk fluid area (i.e., area C in FIG. 6M) and the microchannels. In summary, while slight variations exist between the spatial patterns in electric field gradient simulations and experimentally measured ion concentrations, the generated FITC concentration gradient within a 680 μm by 900 μm chamber is directly dependent on the presence of spatial nonuniformity in an applied AC electric field.

### Example 1.6. 4. Temporal and Spatial Analysis of Intensity Change

Additional temporal and spatial analyses were performed to further characterize the FITC concentration gradient within the microchamber. FIGS. 6A-6N show experimental results at 10 Vpp and 100 Hz in 4.3×10⁻⁴ S/m and a 2 μM FITC solution. Each individual image includes the average FITC concentration out of five repeated tests. The photobleaching-corrected data were then fit to the calibration curve shown in FIG. 3C to obtain FITC concentrations, as shown in FIGS. 6E-6H. FIGS. 6A, 6E and 61 shows results at t=0. FIGS. 6B, 6F and 6J show results at t=7 s (2 s after applied electric field). FIGS. 6C, 6G and 6K show results at t=30 s. FIGS. 6D, 6H and 6L show results at t=60 s. FIGS. 6A-6D show a 2-D grayscale intensity image. FIGS. 6E-6H show the FITC concentration in 3-D mesh images where the z-axis demonstrates FITC concentration, and the contour plots were all generated by MATLAB.

FIG. 6M shows the areas from which averaged the FITC concentration was obtained using Image J. The areas were chosen according to the contour plot shown in FIG. 6L. Area A shows the highest emission intensity and thus the highest FITC concentration during the entire experiment. Area B is the area surrounding the tip of the vertical electrode. Area C is the bulk solution area, where FITC concentration stayed relatively constant. Areas D and E are corner areas where lower emission intensity was attributed to FITC concentration depletion. Areas B, C, D, and E are all symmetric around the vertical electrode indicated by the white dashed line of symmetry. The inset in FIG. 6M shows interest area F, where the electric field density was the strongest, representing the greatest AC electrokinetic phenomena. Area G represents the entire chamber.

FIG. 6N shows the average FITC concentration for each specific area as a function of time. At t=0, when no electric field was applied, FIGS. 6A, 6E and 61 demonstrate uniform intensity. For subsequent analysis, this initial intensity is always normalized to 75 arb. unit to reference experiment to experiment comparisons. FIG. 6N shows this flat concentration in all regions for the first 4.9 s. These plots demonstrate the uniform FITC concentration distribution in the microdevice system when the system is free of impact from a nonuniform electric field. At t=7 s, 2 s after applying the electric field, FIGS. 6B, 6F and 6J demonstrate that the FITC concentration increased to ~6 μM in area A, remained constant in areas B and C, and decreased slightly in corner areas D and E. Another observation is that the pattern of the FITC concentration enrichment over the first 2 s matches closely with the electric field density distribution shown in FIG. 5C, consistent with the electromigration mechanism discussed prior.

The first 2 s correspond to the first 200 cycles of alternating current oscillation and demonstrate a net enrichment of FITC ions into the high electric field density areas near the electrode and depletion from corner regions farthest from electrodes. Since enrichment is dominated by electromigration, the depletion can be attributed to mass conservation. FITC ions migrated from the weakest electric field areas toward the strongest electric field areas and there is insufficient time for diffusion from the side channels to replenish the depleted area. More specifically, the diffusivity of FITC D=4.9×10-10 m²/s yields a diffusion time of t≈x²/2D=10 s to travel the x distance of 100 μm. Thus, FITC molecules have insufficient time to travel from the side channel to the chamber.

At t=30 s, peak FITC concentrations approaching 10 μM were detected in a subset of area A (FIGS. 6G and 6K). In peripheral areas B, moderate FITC concentrations around 4.5 μM were observed and the magnitude of enrichment decreased with increasing distance from the high field density area (FIGS. 6G and 6K). From 30 to 60 s, observed FITC concentrations demonstrated a collective relaxation over the entire area. The most rapid concentration decreases were observed in areas B and E (FIG. 6N), while FITC concentrations <1 μM were observed in corner areas D and E (FIGS. 6L and 6N). Importantly, the FITC concentration in the entire imaged area (area G) remained largely unchanged, consistent with the conservation of total FITC molecules within the system.

These spatiotemporal FITC concentration changes can be attributed to the combined effect of electromigration, residual Faradaic reactions, and diffusion with electromigration significantly dominating. At t=7 s, FITC ions experience strong biased electromigration and accumulation into three- to five-fold concentration increases in areas with the highest electric field density. From t=7 s to t=30 s, the relatively strong biased electromigration induced FITC ion concentration increases in areas A and B with high electric field density, with a corresponding depletion of FITC ion in areas D and E with low electric field density consistent with the N—P conservation equation. The overall observed concentration decrease from 30 to 60 s can be partially attributed to residual Faradaic reactions decreasing the environment pH and thus the FITC emission intensity, as shown in the control experiment (FIG. 4N). The FITC concentration remained relatively stable in area C, which had low electric field density as well as a direct connection with inlet/outlet channels that act as sources of a 2 μM solution. Thus, area C has the greatest propensity to illustrate a balanced effect between electromigration and diffusion.

In summary, area G illustrates conservation of FITC within the entire observed system, while areas A and F showed significant FITC concentration increase and areas C, D, and E's concentration decreases dominated by electromigration effects. From 30 to 60 s, FITC concentration stabilized as electromigration reached a quasi-equilibrium balance with diffusion. Residual Faradaic reactions probably contributed to the measured FITC emission intensity decrease, even if the ion concentration may not have actually decreased. Therefore, in the next section, frequency and peak-to-peak analyses were performed on FITC concentrations at t=30 s instead of at t=60 s to exclude effects from Faradaic reactions best isolate and analyze electromigration.

### Example 1.6.5. Peak-to-Peak Potential and Frequency Dependency

Applicant further hypothesized that the concentration gradients generated could be easily controlled by changing Vpp and frequency of the applied AC field. To test Applicant's hypothesis, the potential and frequency dependency of FITC concentrations were examined from 5 to 10 Vpp at a fixed frequency of 100 Hz and from 100 to 500 Hz (relative frequency=5-25) at a fixed applied potential of 10 Vpp. The minimum potential and frequency were determined according to the observed negligible intensity increase below 5 Vpp and above 500 Hz. The maximum potential and frequency were determined due to observed shorter device life at frequencies below 100 Hz and instrument maximum Vpp. Average intensity shifts in interest area F between t=5 and 35 s were examined since the strongest indicators of electromigration were prominent between the electrodes in FIGS. 6A-6N.

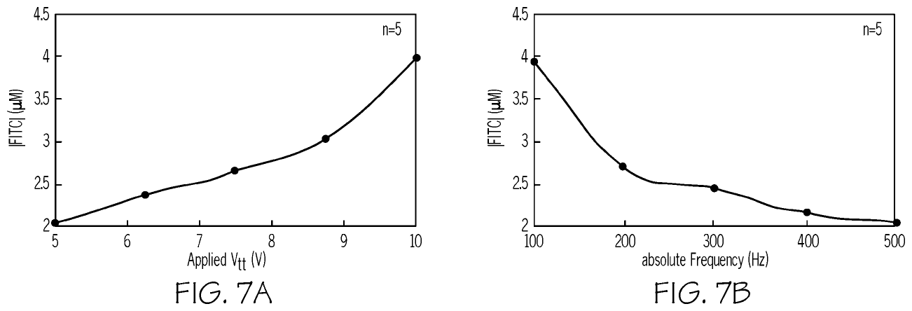

FIGS. 7A and 7H demonstrate the average FITC concentration from five repeat experiments for each potential/frequency condition, while standard deviations of <0.1 μM demonstrate the high reproducibility of this reported approach. Electrical potential dependency results indicate that the magnitude of the FITC concentration increased with Vpp (FIG. 7A). The FITC concentration remained unchanged from the initial concentration of 2 μM at 5 Vpp but reached 4 μM in a 10 Vpp field.

The increased magnitude of enrichment with Vpp is consistent with dielectrophoretic governing equations in which larger applied potentials yield greater electric field density gradients. Physically, an increased magnitude of enrichment with Vpp can be understood as higher applied potentials provided stronger electric fields, causing ions to migrate further in each half cycle of the AC signal. As a result, the rate of establishment and magnitude of the FITC concentration gradient is greater at higher applied potentials.

Frequency dependency results indicate that the magnitude of the FITC concentration decreased with frequency. However, the FITC concentration gradients still existed at 400 Hz, a value 20 times higher than the electrode charging frequency. This decreased magnitude with increasing frequency agreed with a previous theoretical study where an analytical solution of the Poisson-Nernst-Planck (PNP) equation under applied AC potentials was reported, and suggested that the change of ion concentrations with time was inversely related to frequencies of the applied signal. The analytical solutions in the prior study corroborate Applicant's results that the concentration is inversely related to the applied frequency. The physical mechanism of the decreased FITC concentration with frequency is probably due to the decreased available time for ion migration within each half cycle of the applied signal, which leads to attenuated concentration gradients.

### Example 1.7. Conclusions

In this Example, Applicant demonstrated the feasibility of a novel reaction-free approach for generating a spatiotemporally controllable gradient within a batch microfluidic system. This approach is based on biased electromigration induced by spatially nonuniform AC electric fields. Control experiments were carefully designed and conducted illustrating electrothermal effects, diffusion, Faradaic reactions, and convection were minimal or negligible. Through strategic calibration and careful control, this body of experiments verified that the observed intensity changes were induced by the electromigration-driven formation of an ion concentration gradient. The spatial and temporal properties of generated gradients were systematically characterized via the parametric dependence of two driving factors, peak-to-peak potential and frequency, on the FITC concentration gradient. Concentration gradients were generated within 10 s after applying the electric field and remained stable over the course of 60 s experiments. Results demonstrated up to a fivefold increase in the maximum concentration above the initial concentration. Additionally, the magnitude of generated gradients can be accurately and reproducibly controlled via the applied peak-to-peak potential and frequency. Concentration gradients were shown to increase with increased potential and decrease with the increased frequency of the applied AC fields. To the best of Applicant's knowledge, this is the first demonstration of a reaction-free approach for generating spatiotemporally controllable concentration gradients by leveraging the unique properties of spatially nonuniform AC electric fields.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above but is only limited by the claims, including all equivalents of the subject matter of the claims. The disclosures of all patents, patent applications, and publications cited herein are hereby incorporated herein by reference to the extent that they provide procedural or other details consistent with and supplementary to those set forth herein.

1. A method of enriching one or more molecules in a medium, said method comprising:
applying a spatially non-uniform alternating current electric field (AC electric field) to the medium, wherein the AC electric field enriches the molecules in the medium through initiating electromigration of the molecules.

2. The method of claim 1, wherein the AC electric field is defined by the following formula:
$$\frac{{z}_{i} F}{RT} {D}_{i} {C}_{i} {\vec{∇}}^{2} ⌀ \neq 0 ,$$
wherein Zᵢ is the valence of the molecules, F is Faraday's constant, R is the gas constant, T is the medium temperature, Dᵢ is the diffusion coefficient, Cᵢ is the molecule concentration, and φ is the electric potential applied to the medium.

3. The method of claim 1, wherein the AC electric field is applied to the medium through an electrode, wherein the electrode comprises a conductive layer and a dielectric layer positioned above the conductive layer, wherein the conductive layer is operational to provide the AC electric field, and wherein the dielectric layer is operational to inhibit electron-transfer induced electrochemical reactions.

4. The method of claim 3, wherein the dielectric layer comprises a pin-hole fee dielectric layer.

5. The method of claim 3, wherein the electrode comprises a Hafnium Dioxide (HfO₂)-based dielectric layer coated on a conductive layer comprising Ti and Au.

6. The method of claim 1, wherein the electromigration occurs independently from bulk convective flow.

7. The method of claim 1, wherein the electromigration occurs without the molecules undergoing a chemical reaction.

8. The method of claim 1, wherein the electromigration is directed towards a first electrode of an electrode pair that provides the AC electric field, and away from a second electrode of the electrode pair.

9. The method of claim 1, wherein the enrichment comprises selective enrichment of the molecules over other molecules.

10. The method of claim 1, further comprising a step of controlling the level of enrichment.

11. The method of claim 10, wherein the controlling comprises adjusting at least one of voltage, frequency, amplitude, or potential of the AC electric field.

12. The method of claim 1, wherein the medium comprises a liquid medium.

13. The method of claim 12, wherein the liquid medium comprises a non-ionic solvent.

14. The method of claim 1, wherein the molecules are selected from the group consisting of charged molecules, uncharged molecules, macromolecules, biomolecules, proteins, or combinations thereof.

15. The method of claim 1, further comprising a step of collecting the medium, wherein the medium comprises the molecules to be enriched.

16. The method of claim 1, further comprising a step of sensing the enriched molecules.

17. The method of claim 1, further comprising a step of purifying the one or more enriched molecules.

18. A system for enriching one or more molecules, said system comprising:
a housing unit, wherein the housing unit is operational to house a medium comprising the molecules; and
an electrode, wherein the electrode is operational to be electrically connected to the medium and apply a spatially non-uniform alternating current electric field (AC electric field) to the medium.

19. The system of claim 18, wherein the housing unit is in the form of a fluidic chamber.

20. The system of claim 18, wherein the electrode comprises a conductive layer and a dielectric layer positioned above the conductive layer, wherein the conductive layer is operational to provide the AC electric field, and wherein the dielectric layer is operational to inhibit electron-transfer induced electrochemical reactions.

21. The system of claim 20, wherein the dielectric layer comprises a pin-hole fee dielectric layer.

22. The system of claim 20, wherein the electrode comprises a Hafnium Dioxide (HfO₂)-based dielectric layer coated on a conductive layer comprising Ti and Au.

23. The system of claim 18, wherein the system is in the form of a wearable sensor.
